(19) United States
(12) Patent Application Publication
(10) Pub. No.: US 2007/0133835 A1
(43) Pub. Date: Jun. 14, 2007

(54) OTOPLASTY FOR BEHIND-THE-EAR (BTE) HEARING AIDS

(76) Inventor: Erich BAYER, Straubing (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/678,340

(22) Filed: Feb. 23, 2007

Related U.S. Application Data
(62) Division of application No. 10/790,126, filed on Mar. 2, 2004.
Application No. 10/790,126 is a continuation of application No. 10/030,191, filed on Jun. 6, 2002, now abandoned.

(30) Foreign Application Priority Data
Oct. 14, 1999 (DE) 299 18 139.1
Jun. 2, 2000 (DE) 200 09 908.6

(51) Int. Cl. H04R 25/00

(52) U.S. Cl. 381/330

(57) ABSTRACT

An otoplastic for production of behind-the-ear hearing aids. The hearing aid includes a preferably flexible signal conductor, such as e.g. an acoustic tube positioned in the auditory canal, whereby the otoplastic matches the individual anatomy of the patient and its locating part is in the form of a clip, which, at least partly arched, follows the outer edge of the cavum conchae. A branch which following the edge of the cavum conchae transforms, above the antitragus, into a bent crosspiece traversing the cavum conchae and extending in the direction of the porus acusticus externus. The end section of said crosspiece lies in the upper section of the auditory canal and widens to accept the signal conductor.

### BACKGROUND OF THE INVENTION

1. Field of the Invention

The invention relates to an ear fitting piece, i.e. an earpiece for behind-the-ear (BTE) devices in the field of hearing acoustics. These devices are also frequently referred to as BTE-secret-ears (SE). In this connection, a relatively short sound tube is used, making it possible to noticeably reduce friction losses, particularly in the high-frequency sonic range.

2. Discussion of the Background

However, the sound tube must, be precisely positioned in or on the auditory canal, and for this purpose, an ear fitting piece, i.e. an earpiece is regularly used, which is individually adapted to the human anatomy of the ear of the patient to be treated. Up to the present date, various forms of earpieces have become common, with some, namely the so-called “open” BTE earpieces, being particularly preferred, in order to have the minimum possible effect on the auditory canal, caused by partially covering or closing it off in some regions, with a “foreign body.” These “open” BTE devices have the further advantage that the hearing capacity that still exists is impaired as little as possible in terms of its natural effect.

Known relevant earpieces are known as “SE shell shape, SE clip shape, or SE claw shape” (See Ulrich Voogdt: Otoplastik—Die individuelle Otoplastik zur Hörgeräte-Versorgung . . . [Earpieces—Individual earpieces for hearing aids . . . ], Volume 2 of the scientific series “Akademie für Hörgeräte-Alkustik” [Academy for hearing device acoustics), Median-Verlag of Killisch-Horn GmbH, 1993). A modified version of these common earpieces is the “open” solution. However, all of the variants have the common feature that it is frequently not possible to make the hearing correction as natural as possible.

### SUMMARY OF THE INVENTION

It is therefore the task of the invention to create an earpiece for an “open” BTE hearing aids, for CI components (cochlear implant microphone systems and CI BTE processors), or BTE tinnitus systems, which are characterized not only by a minimal feeling of wearing a foreign body, and good wearing comfort, but primarily in that natural sound processing in the human ear can be utilized with as little distortion as possible, in order to ensure a maximum degree of hearing correction and sense of natural hearing.

This task is accomplished by an earpiece according to the present invention.

With the earpiece according to the invention it is possible to keep the auditory canal open at the decisive points, to a degree that has not been achieved until now. The invention is based on the consideration that the sense of natural hearing, on the one hand, and the effectiveness of the hearing correction, on the other hand, are significantly influenced by the anatomically determined, natural resonance conditions in the auditory canal, including the external ear. Using the structure of the earpiece according to the invention, the natural resonance remains largely unaffected, even if the auditory canal is very narrow. In this connection, there are the additional advantages that the wearing comfort is extremely good (material-free region in the region of the crus helicis; no accumulation of heat), that the earpiece requires very little material and therefore also has cosmetic advantages, and that acoustic coupling for influencing the frequency and the dynamics can take place more free of complications.

Although the earpiece according to the invention takes up less room, it can reliably fulfill the function of stabilizing the sound tube, in that the coupling between the sound tube and the BTE device is utilized for stabilization.

It has been shown that the support elements of the earpiece are positioned in such a stable manner, in spite of the reduced contact area with the cavum conchae, that the end segment of the earpiece traverse part can carry an auditory canal tab, in accordance with the further development in Claim 2, making it possible to achieve better support in the auditory canal.

The task stated above is accomplished in accordance with a second alternative in that the earpiece is, for the first time, positioned at a location of the external ear that lies entirely outside of the cavum conchae. It has surprisingly been shown that when positioning the part of the earpiece that provides the hold in the cymba, it is easily possible, in interaction with the inherent stability of the flexible signal conductor or the sound tube, to precisely and reproducibly position the latter in the auditory canal, which is no longer blocked off by an earpiece component, according to the invention. In this way, this earpiece is particularly well suited, in addition to “open” standard applications, for applications in children with deafness in one ear, or, for example, for students with normal hearing but with a so-called reading/spelling weakness, in connection with so-called FM (frequency modulation) systems in which the teacher's speaking signal is fed into the auditory canal of the hearing-challenged child via a microphone and a microport system. Particularly in this case, utilization of the natural auditory canal resonance is very important, and this is achieved by the earpiece according to the invention, to a degree that has not been achieved until now. Because of the improved general conditions, it is furthermore easier to undertake acoustical coupling of the hearing device to the frequency and dynamics influencing system, so that the earpiece according to the invention is also well suited for use in media, e.g. during live television interviews, as a type of “in-ear monitoring,” where in this case, a simultaneous translation, for example, or the voice signal of a prompter, are tea into the auditory canal under the most natural conditions possible.

A particular advantage of the earpiece according the present invention can be seen in that there is great freedom with regard to the structure of the clip that goes around the external ear in the shape; of an arc, which in turn can be utilized for additional stabilization of the earpiece.

If the main body of the earpiece that provides the hold is extended into the region of the crus anthelicis, stabilization of the main body is further improved, which makes it possible to further reduce the size of the main body. At the same time, this improves the wearing comfort, and it also has advantages in terms of cosmetics.

This embodiment, just like the first embodiment, has the advantage that it can be used without complications for specific special applications, such as a very narrow auditory canal or a lot of hair at the end of the auditory canal, or other anomalies of the ear anatomy.

Further developments of the invention are described hereafter in the specification and claims.

### BRIEF DESCRIPTION OF THE DRAWINGS

In the following, exemplary embodiments of the invention will be explained in greater detail, using the schematic drawings. These show:

FIG. 1 is a view of an ear from the side, with the earpiece according to the first embodiment inserted in, it;

FIG. 2 is a cross-sectional view taken along line II-II in FIG. 1;

FIG. 3, and FIG. 4 on a larger scale, illustrate representations of an actual manufactured earpiece of the embodiment according to FIGS. 1 and 2;

FIG. 5 is a view of an earpiece placed in an external ear, according to the construction corresponding to the first embodiment;

FIG. 6 is a view of an ear from the side, with the earpiece according to the second embodiment inserted in it;

FIG. 7 is a cross-sectional view taken along line VII-VII in FIG. 6;

FIG. 8, and FIG. 9: on a larger scale, illustrate representations of an actual manufactured earpiece of the embodiment according to FIGS. 6 and 7;

FIG. 10 is an enlarged view of another embodiment of the earpiece, with a main body of a smaller size; and

FIG. 11 is a view of an earpiece according to FIG. 10, placed in an external ear;

FIG. 12 a view of a variant of the earpiece according to FIG. 1 to 5, corresponding to FIG. 1;

FIG. 13 a view of the earpiece according to FIG. 12;

FIG. 14 a view of a modification of the earpiece according to FIG. 12;

FIG. 15 a cross-sectional view of the embodiment according to FIG. 14;

FIG. 16 a view of a further development of the earpiece according to FIG. 6 to 11, corresponding to FIG. 11;

FIGS. 17 and 18 views of a first embodiment of the earpiece according to FIG. 16;

FIG. 19 a view of the earpiece according to FIGS. 17 and 18, similar to FIG. 13;

FIGS. 20 and 21 views of a second embodiment of the earpiece according to FIG. 16;

FIGS. 22 and 23 views of a third embodiment of the earpiece according to FIG. 16;

FIGS. 24 and 25 views of a variant of the third embodiment of the earpiece according to FIGS. 22 and 23.

### DETAILED DESCRIPTION OF THE PREFERRED EMBODIMENTS

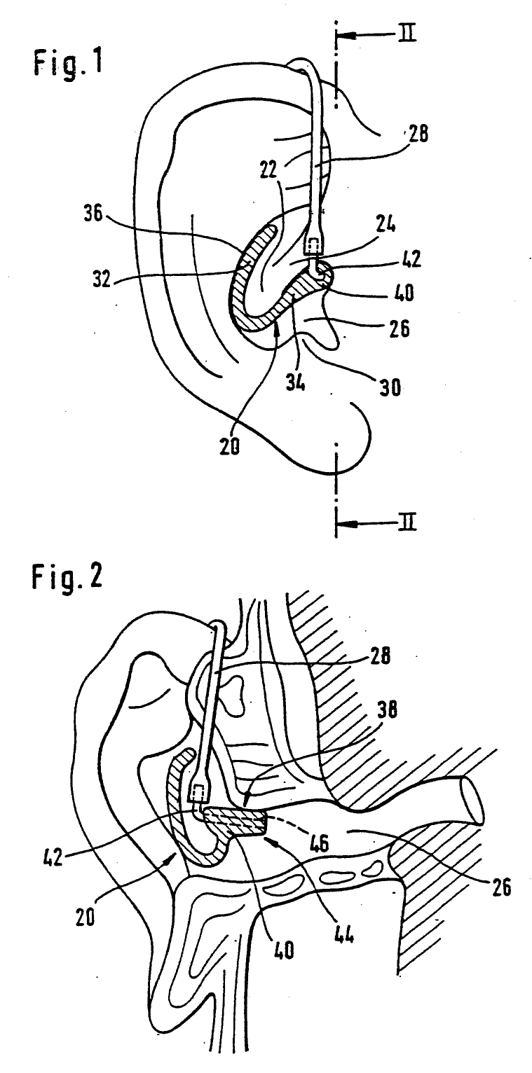

FIG. 1 shows an earpiece, with the reference number 20, for a BTE device, which is used in the cavum conchae, referred to with the reference number 22. The crus helicis is referred to with the reference number 24, and the auditory canal, i.e. the meatus acusticus externus, is referred to with reference number 26.

The earpiece serves to stabilize a sound tube 28 that leads to the BTE device, not shown, which tube opens into the auditory canal. For this purpose, the earpiece is individually adapted to the anatomy of the patient, for example by means of an impression-taking procedure. It essentially has the shape of a clip with two shanks 32, 34. The first shank extends in an arc shape along the outer edge 36 of the cavum conchae 22 up to a point above the antitragus, referred to as 30. From there, the earpiece runs at an angle, upward, via a second shank that passes through the cavum conchae, which will be referred to as the traverse segment 34 in the following discussion. The traverse segment runs in the direction of the porus acusticus externus 38 and there widens to an end segment 40, which serves to hold the signal conductor, in the case shown here, a sound tube angle piece 42.

As is evident from FIG. 2, the end segment 40 makes a transition into an acoustical canal tab 44 in which a bore 46 (shown with broken lines) is formed.

From the drawing, it is evident that the earpiece covers the auditory canal 26 only slightly, so that the natural auditory canal/external ear resonance is maintained. Additional stabilization of the earpiece 20 is achieved with the sound tube 28, which is rigidly connected with the angle piece 42.

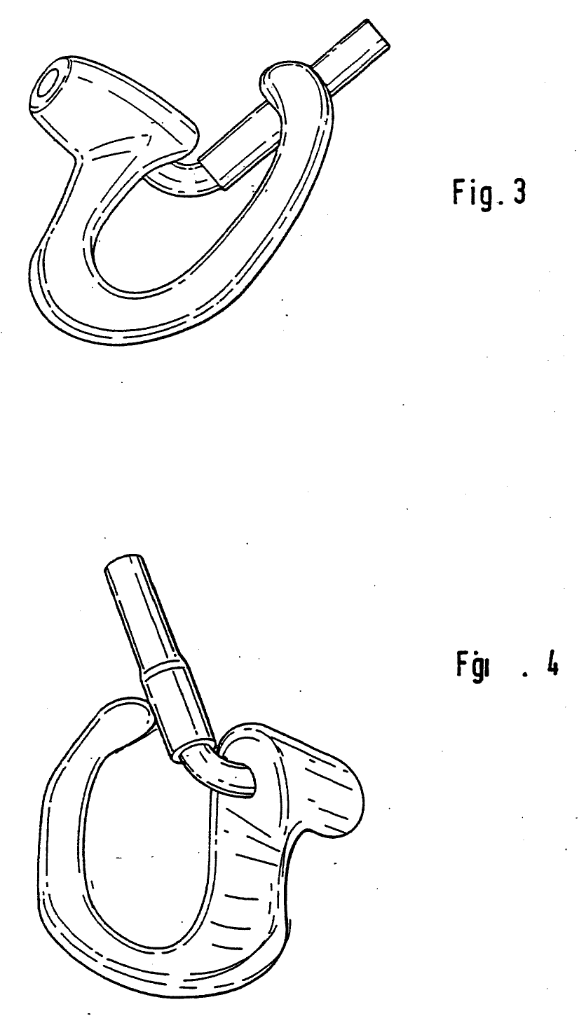

In FIGS. 3 and 4, which show an earpiece according to FIGS. 1 and 2, made of plastic, the filigree structure is clearly evident, but nevertheless the earpiece can be fixed in place in the cavum conchae, in stable manner.

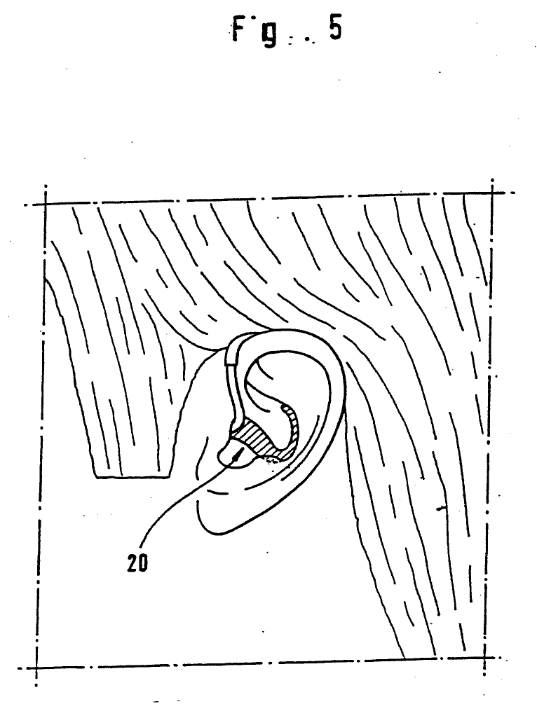

The cosmetic aspect of the earpiece according to the invention is best evident from FIG. 5, in which the visible surface of the earpiece 20 is shown with hatched lines. It is obvious that the design according to the invention is such that it has practically no detrimental effect on the natural appearance of the external ear.

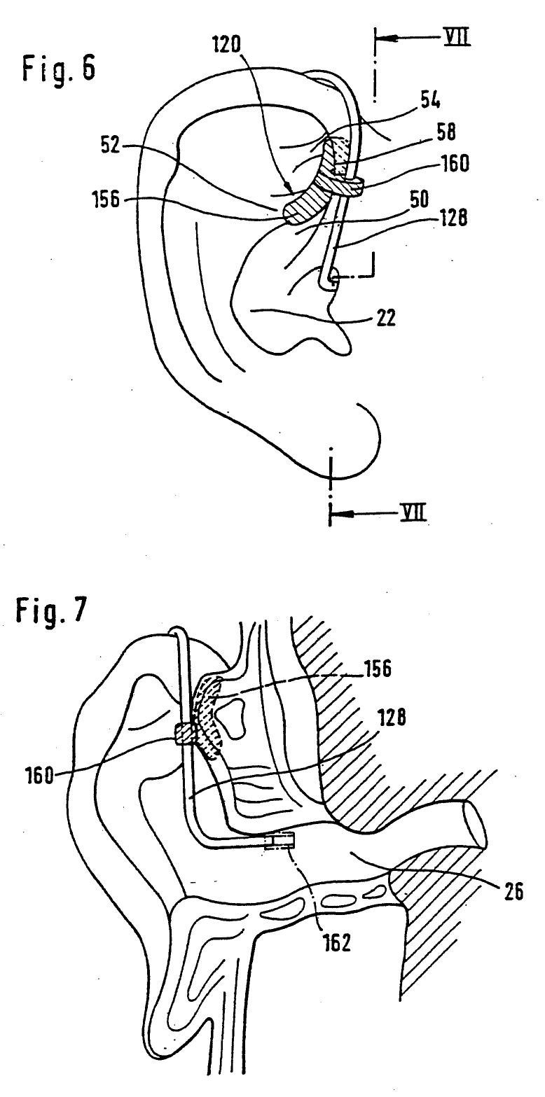

FIGS. 6 to 11 show additional embodiments of the earpiece according to Claim 5.

The earpiece, which again is emphasized with hatched lines, as also in FIGS. 1 and 2, is referred to with the reference number 120. It is arranged in such a way that the cavum conchae remains entirely free. Instead, the earpiece is arranged in the region of the cymba conchae 50, and, in the case shown, with an extension into the region of the crus anthelicis 52, 54.

Again, the earpiece is individually adapted to the anatomy of the patient, and consists essentially of two components, namely the part 156 that provides the hold, which is shaped to fit into the cymba conchae 50, and a hill 160, which forms the holder for the flexible sound tube 128 at its end. The sound tube 128 is inserted at an angle into the interior of the auditory canal 26, as shown in FIG. 7, and can have a so-called cerum defender 162 there, for example.

This embodiment of the earpiece has an even smaller structural volume than the earpiece according to FIGS. 1 to 5, and, as is evident from FIG. 7, it has almost no influence on the auditory canal.

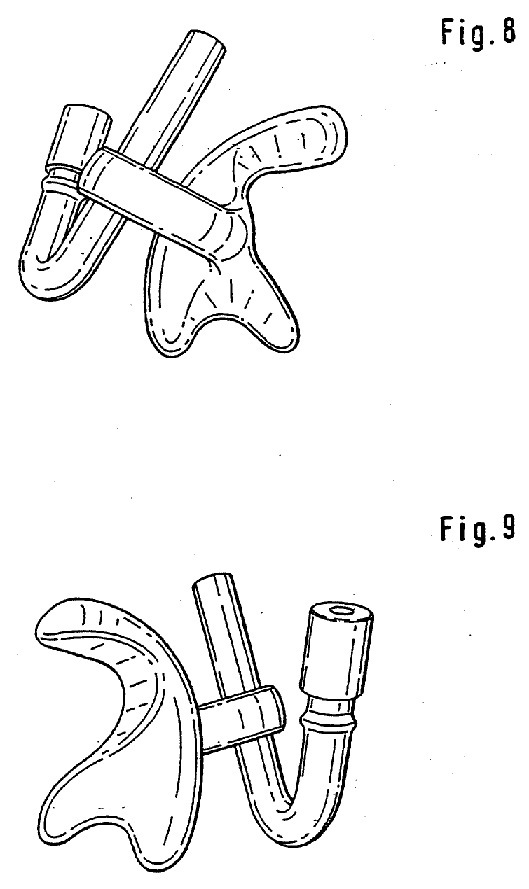

FIGS. 8 and 9 show an earpiece used in practical situations, on a larger scale. The surface structure of the main body, with its multiple curves, is clearly evident; this is responsible for the accurate fit and secure seat in the cymba conchae, which prevents it from being moved. The embodiment according to FIG. 8, 9 was produced for a patient with a rather large-volume cymba conchae.

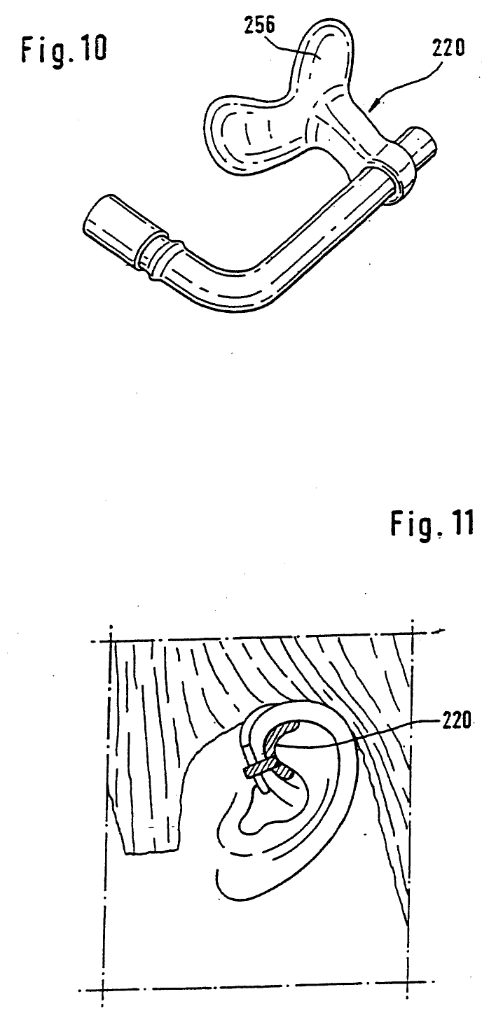

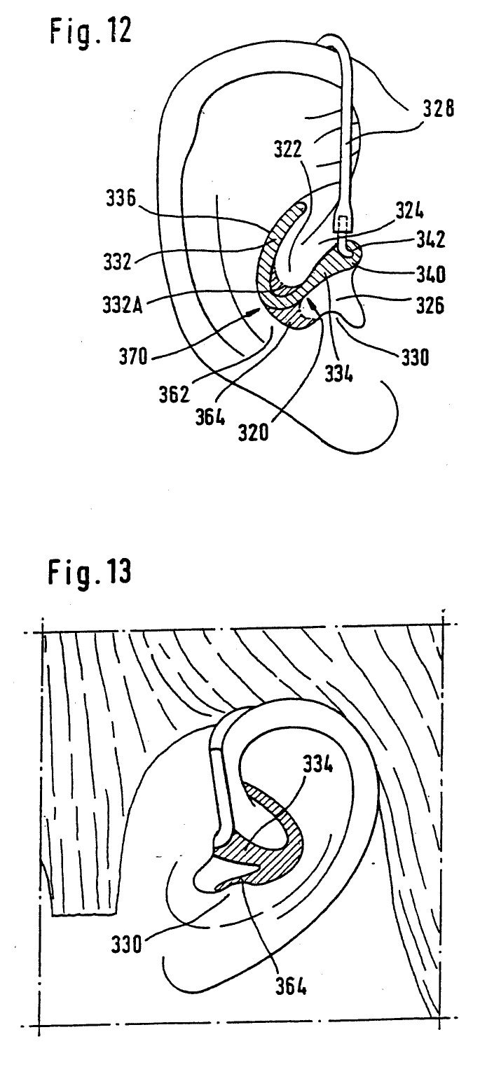

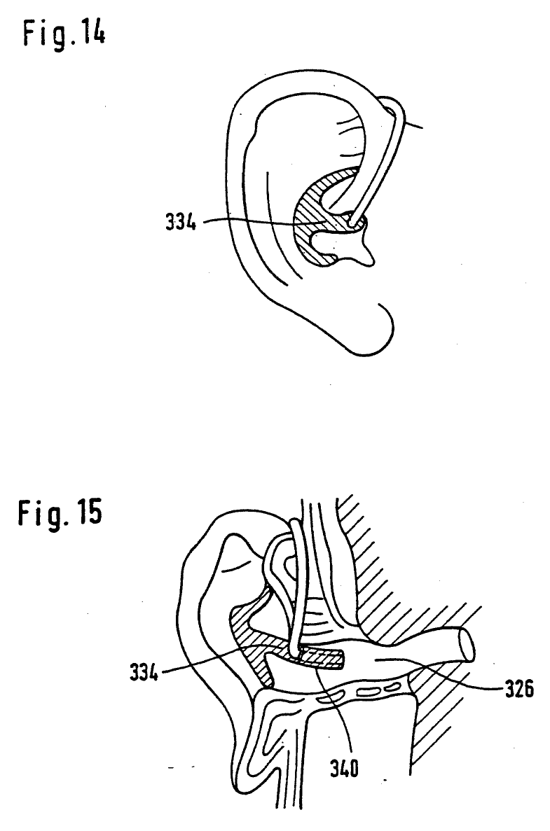

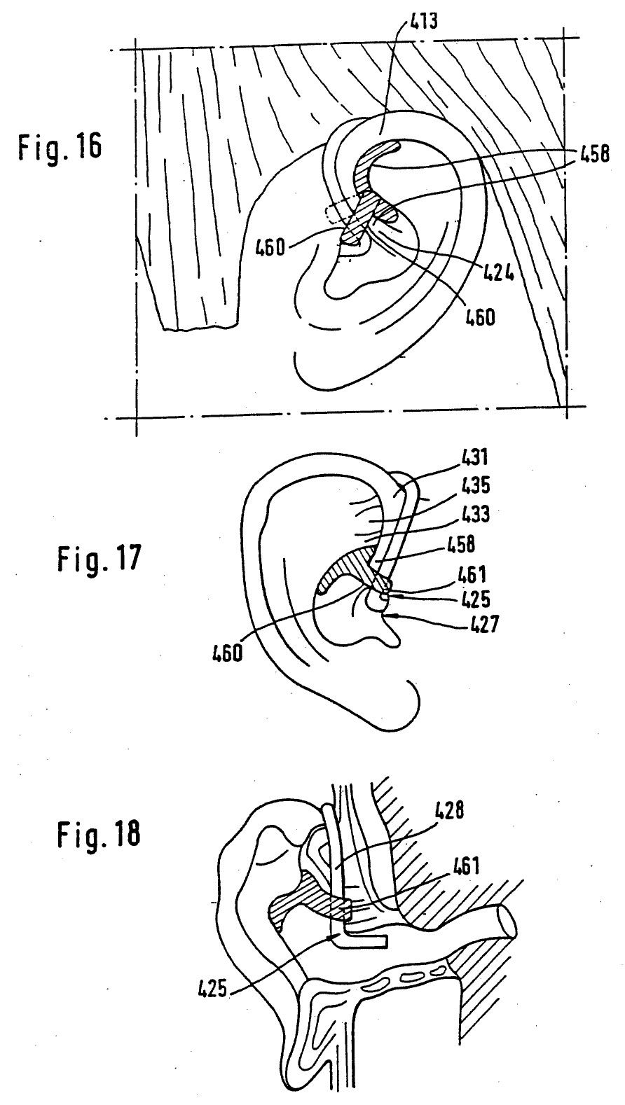

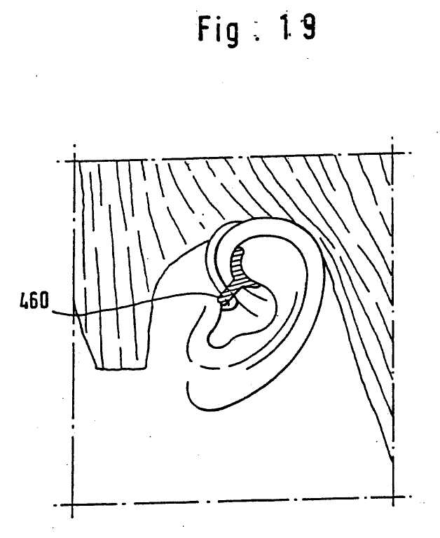

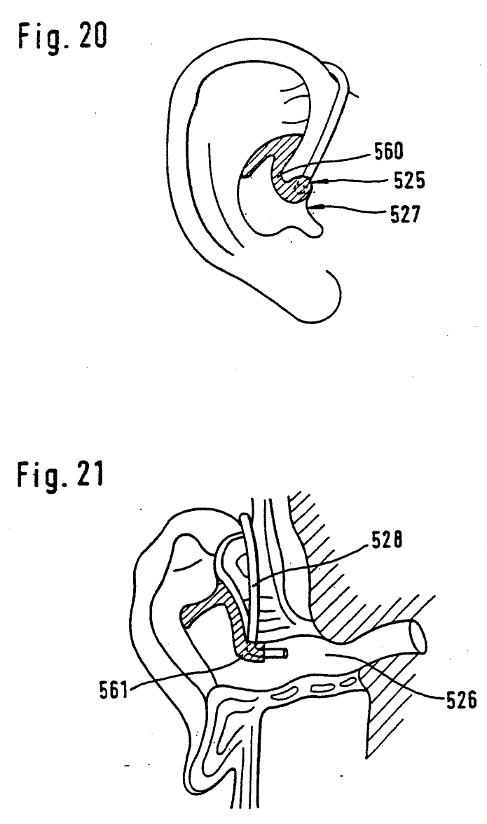

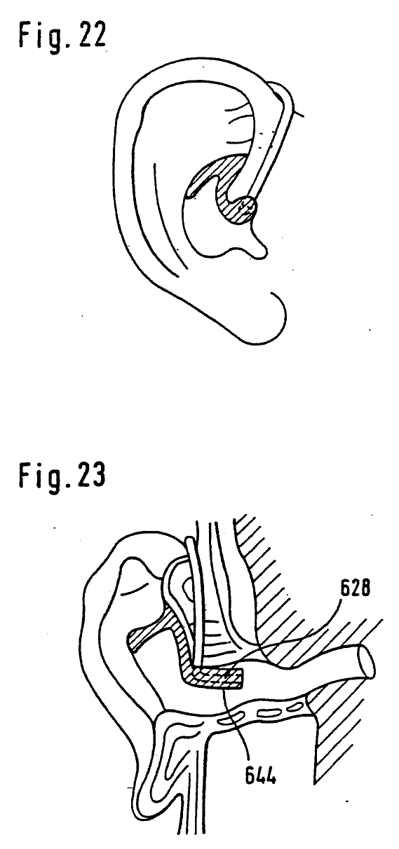

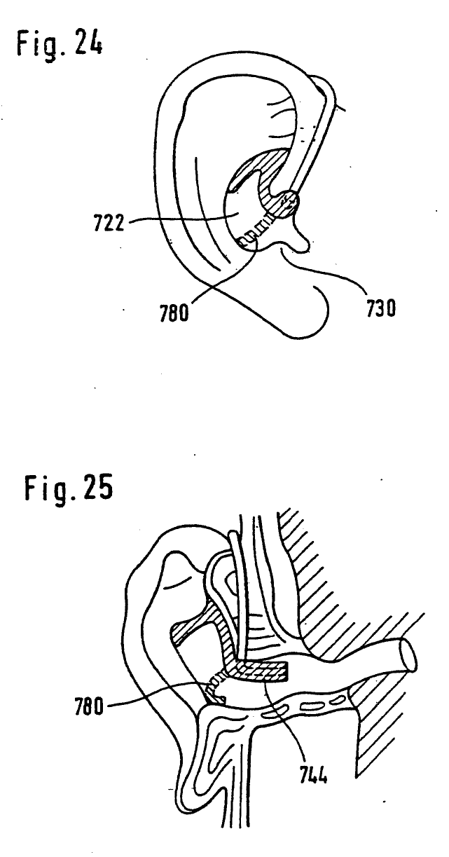

FIGS. 10 and 11 show another embodiment that was used for a patient with a significantly smaller cymba conchae. The earpiece, designated as 220, has a significantly smaller main body 256, which again is spatially curved in many places, so that the necessary undercut with the surface of the ear comes about.

From the view according to FIG. 11, it is evident that the visible part of the earpiece 220 is kept to a minimum.

Of course, all the usual materials can be used for the earpieces according to the invention, such as hot-polymerized and cold-polymerized PMMA or photopolymerizate. Because of the low volume of the earpiece, colored designs, possibly with jewelry-like applications, are also possible. Also, metals such as stainless steel, gold, silver, platinum, titanium (injection-molding or spin-casting process) can be used, and it is also possible to work with galvanic technology.

1. Earpiece for behind-the-ear parts of hearing acoustics devices, comprising:
a body including a first portion adapted to fit into a patient's cymba conchae and a second portion extending around an edge of the patient's inner ear; and
a protrusion extending from the body, the protrusion defining a bore configured to hold a signal conductor in an upper half of the patient's auditory canal and to prevent the signal conductor from covering a portion of a lower half of the patient's auditory canal.

2. Earpiece according to claim 1, further comprising:
a flexible signal conductor disposed in the protrusion.

3. Earpiece according to claim 2, further comprising:
a protective device disposed on an end of the flexible signal conductor to prevent injury to the patient's auditory canal.

4. Earpiece according to claim 1, further comprising:
a flexible signal conductor having a first portion extending in a direction of extension of the protrusion and a second portion extending in a direction about perpendicular to the first portion,
wherein the first portion is disposed in the protrusion.

5. Earpiece according to claim 1, further comprising:
a flexible signal conductor having a first portion extending in a direction of extension of the protrusion and a second portion extending in a direction about perpendicular to the first portion,
wherein a transition point between the first and second portions of the flexible signal conductor is disposed adjacent the protrusion.

6. Earpiece according to claim 1, wherein the second portion is adapted to fit into the patient's crus anthelicis.

7. Earpiece according to claim 1, wherein the protrusion is adapted to bridge a top segment of the patient's crus helices.

8. Earpiece according to claim 1, wherein the protrusion comprises a broadened portion defining the bore.

9. Earpiece according to claim 1, wherein the protrusion is configured to hold the signal conductor above the patient's incisura anterior, between the patient's tragus and the patient's crus helicus.

10. Earpiece according to claim 1, wherein the protrusion is configured to be recessed between the patient's incisura anterior and the patient's tragus, in an entrance region of the patient's auditory canal.

11. Earpiece according to claim 1, wherein the protrusion is configured to be disposed apart from an upper region of the patient's auditory canal.

12. Earpiece according to claim 1, wherein the protrusion comprises a support portion configured to extend from a bottom portion in a direction of the patient's antitragus against the patient's cavum conchae.

13. Earpiece according to claim 1, wherein the at least one of the body and the protrusion is adapted for use with cochlear implant microphones, CI BTE processors, and BTE tinnitus systems.
